(19) United States
(12) Patent Application Publication
(10) Pub. No.: US 2019/0119107 A1
(43) Pub. Date: Apr. 25, 2019

(54) CHEMICAL LOOPING SYSTEMS FOR CONVERSION OF LOW- AND NO-CARBON FUELS TO HYDROGEN

(71) Applicant: OHIO STATE INNOVATION FOUNDATION, Columbus, OH (US)

(72) Inventors: Liang-Shih FAN, Columbus, OH (US); Mandar KATHE, Columbus, OH (US); Deven Swapneshu BASER, Columbus, OH (US)

(21) Appl. No.: 16/091,508

(22) PCT Filed: May 25, 2017
(86) PCT No.: PCT/US17/34503

§ 371 Date: Oct. 4, 2018

Related U.S. Application Data
(60) Provisional application No. 62/341,294, filed on May 25, 2016.

(51) Int. Cl. C01B 3/04; B01J 19/18; B01J 8/04; B01J 8/28; B01J 23/745

(52) U.S. Cl. CPC C01B 3/047; B01J 19/1837; B01J 8/0457; B01J 8/28; B01J 2208/00539; B01D 2257/108; B01D 2256/10; B01J 2208/00557; B01J 2203/0605; B01J 23/745

(57) ABSTRACT

Disclosed herein are systems and methods for producing H2 from low carbon fuels (LCFs) using metal oxides in a chemical looping process.

### CROSS-REFERENCE TO RELATED APPLICATION(S)

This patent application claims the benefit of priority to U.S. Provisional Application No. 62/341,294, filed on May 25, 2016, the entire contents of which are hereby incorporated by reference.

### TECHNICAL FIELD

The intense debate on climate change triggered by greenhouse gas emissions from anthropogenic activities has led to extensive research efforts towards concepts like H₂ economy. H₂ as fuel burns without harmful emissions; however, the transportation of H₂ from its production site makes current large scale deployment a challenge. Several carbon-neutral or low carbon fuels (LCFs) have been investigated as sources of H₂ as they are more economical to transport over longer distances. Large scale utilization of these fuels is predicted to significantly improve the market penetration of utilization of H₂ as a fuel. This disclosure describes a low temperature process which utilizes a looping schematic for high-efficiency conversion of LCFs to H₂.

### BACKGROUND

The traditional generation of H₂ from LCFs is based on catalytic thermal cracking, followed by a Pressure Adsorption for H₂ separation. LCFs include fuels such as ammonia (NH₃), hydrazine (N₂H₄), carbohydrazide (CH₆N₄O), hydrogen sulfide (H₂S), etc. Using NH₃ as an example, the conventional process suffers from several drawbacks including high energy consumption and operating temperature requirement for high efficiency thermal cracking (700-1100 ° C.); reduction in the overall H₂ production (˜20% lower) and thermochemical efficiency reduction (at least 12.7%) as a result of providing for the net endothermic heat of reaction. Many new technologies strive to achieve the thermal cracking by developing better catalysts (which will function at lower temperatures) or newer chemistries (such as Li-imide based high-efficiency reactions). The use of transition metals, rare earth metals, and alkaline earth metals as active sites for no-carbon based fuels decomposition to hydrogen has been thoroughly investigated before. Catalytic decomposition of ammonia has been investigated over a variety of catalysts made from several active metals, and these have been investigated at a temperature range of 400-700° C. The majority of the catalysts that are explored are mixed metal oxide catalysts operated at high space-velocities. These catalysts deal with a trade-off between low ammonia conversion and over-oxidation to H₂O, which leads to a loss of efficiency.¹ A method for utilizing aluminum oxide pellets with catalytically active metals deposited onto it to decompose ammonia at a temperature range of 500-700° C. has also been proposed. The decomposition process has several technological limitations including efficient heat transfer and scale-up associated with heat release from the pellets.² A ruthenium based catalyst over carbon nanotube support has been one of the most effective catalysts for ammonia decomposition which is reported in the literature.³ However, cost of making this novel catalyst might offset the economic feasibility of the process.⁴ The amide-based approaches have the intrinsic limitation of being explosive, hazardous and lead to problems in ammonia based scale-up. Decomposition of ammonia over a lithium amide-imide catalyst has been investigated. However, due to low melting points of both the amide and the imide phase, it is not the most convenient catalyst to work within a fixed bed condition.⁵

### SUMMARY

The present disclosure may overcome the limitations associated with the conventional LCF to H₂ processes by employing a novel looping based system. The disclosure provides specific conditions that enable the disclosed looping process to achieve high H₂ production and energy efficiencies in terms of the reactor design, reactor operating conditions, metal-oxide composition, and specific metal-oxide and LCF flowrates. Due to their relatively high hydrogen content, fuels such as ammonia (NH₃), hydrazine (N₂H₄), carbohydrazide (CH₆N₄O), hydrogen sulfide (H₂S), etc. can be classified as LCFs. This process utilizes a chemical looping scheme to convert efficiently LCF's to H₂ for its use as a fuel. It employs a metal oxide to break the LCF chemically into its constituent components one of them being H₂. Factors such as reactor design, reaction conditions have been considered along with metal oxide compositions in this invention disclosure.

In one aspect, disclosed herein is a system for converting a carbon-neutral or low-carbon fuel, the system comprising: a first reactor comprising a plurality of particles in which a primary metal oxide is disposed on a support, and an inlet for providing a carbon-neutral or low-carbon fuel, wherein the first reactor is configured to reduce the primary metal oxide to produce a reduced metal or a reduced metal oxide; and a second reactor configured to oxidize at least a portion of the reduced metal or reduced metal oxide from the first reactor, to regenerate the primary metal oxide.

In some embodiments, the fuel is selected from the group consisting of ammonia, hydrazine, carbohydrazide, and hydrogen sulfide. In some embodiments, the fuel is ammonia.

In some embodiments, the system is configured to operate at a temperature of between 400° C. and 1190° C. In some embodiments, the system is configured to operate at a pressure of between 1 atm and 30 atm. In some embodiments, the system is configured to operate at a GHSV of between 50 hr⁻¹ and 5000 hr⁻¹. In some embodiments, the first reactor comprises a co-current moving bed reactor, a counter-current moving bed reactor, a fluidized bed reactor, or a fixed bed reactor. In some embodiments, the second reactor comprises a co-current moving bed reactor, a counter-current moving bed reactor, a fluidized bed reactor, or a fixed bed reactor. In some embodiments, the inlet for the fuel is situated at the top, in the middle, or at the bottom of the first reactor.

In some embodiments, the primary metal oxide is Fe₃O₄. In some embodiments, wherein the support is selected from the group consisting of oxides of Ti, Al, Co, Cu, Mg, Mn, and Zn, or any combination thereof. In some embodiments, the support is MgAl₂O₄. In some embodiments, the system further comprises a hydrogen separation unit.

In another aspect, disclosed herein is a method of converting a carbon-neutral or low-carbon fuel, the method comprising: reducing a primary metal oxide in a reduction reaction between the fuel and the primary metal oxide, to produce a reduced metal or a reduced metal oxide, in a first reactor, thereby producing hydrogen; and oxidizing at least a portion of the reduced metal or reduced metal oxide with an oxidant, in a second reactor, thereby regenerating the primary metal oxide.

In some embodiments, the fuel is selected from the group consisting of ammonia, hydrazine, carbohydrazide, and hydrogen sulfide. In some embodiments, the fuel is ammonia.

In some embodiments, the method is conducted at a temperature of between 50° C. and 2000° C. In some embodiments, the method is conducted at a pressure of between 1 atm and 30 atm. In some embodiments, the first reactor comprises a co-current moving bed reactor, a counter-current moving bed reactor, a fluidized bed reactor, or a fixed bed reactor. In some embodiments, the second reactor comprises a co-current moving bed reactor, a counter-current moving bed reactor, a fluidized bed reactor, or a fixed bed reactor. It should be noted that the specific configuration of a moving bed reactor can be achieved using a packed moving bed, staged fluidized bed, a downer and/or a rotary kiln. A fixed bed with dynamic valve switching that approximate a simulated moving bed may also be used. The some embodiments, the method comprises introducing the fuel at the top, in the middle or at the bottom of the first reactor.

In some embodiments, the primary metal oxide is Fe₃O₄. In some embodiments, wherein the support is selected from the group consisting of oxides of Ti, Al, Co, Cu, Mg, Mn, and Zn, or any combination thereof. In some embodiments, the support is MgAl₂O₄. In some embodiments, the method further comprises a step of separating the hydrogen from any co-products.

### BRIEF DESCRIPTION OF THE DRAWINGS

FIG. 1 shows a process flow diagram of ATH technology for liquid fuel production.

FIG. 2 shows a phase diagram of the Fe—NH₃—O system at 450° C. and 1 atm.

FIG. 3 shows an operating line for the reducer reactor at 450° C. and 1 atm.

FIG. 4 shows a phase diagram of the Fe—O—H₂ system at 450° C. and 1 atm.

FIG. 5 shows the gas phase analysis of a fixed bed run with Fe₃O₄ and NH₃ at 600° C. and 1 atm at a GHSV of 500 hr⁻¹.

FIG. 6 shows the gas phase analysis of a fixed bed run with Fe₃O₄ and NH₃ at 600° C. and 1 atm at a GHSV of 150 hr⁻¹.

FIG. 7 shows the solid phase analysis of a fixed bed run with Fe₃O₄ and NH₃ at 600° C. and 1 atm at a GHSV of 500 hr⁻¹.

FIG. 8 shows the solid phase analysis of a fixed bed run with Fe₃O₄ and NH₃ at 600° C. and 1 atm at a GHSV of 150 hr⁻¹.

FIG. 9 shows the steady state composition of a simulated counter current moving bed with Fe₃O₄—MgAl₂O₄ system at 600° C. and 1 atm at a GHSV of 150 hr⁻¹.

FIG. 10 shows the calculated equilibrium constant for experiments with different gas-solid contact pattern demonstrating controllability in reducer reactor performance

FIG. 11 shows the normalized rate of weight change of Fe₃O₄ on reduction with ammonia for 400° C. and 600° C.

FIG. 12 shows the normalized rate of weight change of Fe₃O₄—MgAl₂O₄ on reduction with ammonia for 400° C. and 600° C.

### DETAILED DESCRIPTION

A process is proposed for deriving H₂ from low carbon fuels (LCF) with the use of metal oxide in a chemical looping system. This process employs the synergistic effect of utilizing thermodynamics while being able to harness the catalytic property of the metal oxide. The proposed process is flexible to several LCFs such as ammonia (NH₃), hydrazine (N₂H₄), carbohydrazide (CH₆N₄O), hydrogen sulfide (H₂S), etc., to utilize them as potential sources of H₂ generation. This process can be easily integrated with upcoming concepts like H₂ economy while reducing the carbon footprint for H₂ generation.

### Definitions

The terms “comprise(s),” “include(s),” “having,” “has,” “can,” “contain(s),” and variants thereof, as used herein, are intended to be open-ended transitional phrases, terms, or words that do not preclude the possibility of additional acts or structures. The singular forms “a,” “and” and “the” include plural references unless the context clearly dictates otherwise. The present disclosure also contemplates other embodiments “comprising,” “consisting of” and “consisting essentially of,” the embodiments or elements presented herein, whether explicitly set forth or not.

The conjunctive term “or” includes any and all combinations of one or more listed elements associated by the conjunctive term. For example, the phrase “an apparatus comprising A or B” may refer to an apparatus including A where B is not present, an apparatus including B where A is not present, or an apparatus where both A and B are present. The phrases “at least one of A, B, . . . and N” or “at least one of A, B, . . . N, or combinations thereof” are defined in the broadest sense to mean one or more elements selected from the group comprising A, B, . . . and N, that is to say, any combination of one or more of the elements A, B, . . . or N including any one element alone or in combination with one or more of the other elements which may also include, in combination, additional elements not listed.

For the recitation of numeric ranges herein, each intervening number there between with the same degree of precision is explicitly contemplated. For example, for the range of 6-9, the numbers 7 and 8 are contemplated in addition to 6 and 9, and for the range 6.0-7.0, the number 6.0, 6.1, 6.2, 6.3, 6.4, 6.5, 6.6, 6.7, 6.8, 6.9, and 7.0 are explicitly contemplated.

Unless otherwise defined, all technical and scientific terms used herein have the same meaning as commonly understood by one of ordinary skill in the art. In case of conflict, the present document, including definitions, will control. Preferred methods and materials are described below, although methods and materials similar or equivalent to those described herein can be used in practice or testing of the present invention. All publications, patent applications, patents and other references mentioned herein are incorporated by reference in their entirety. The materials, methods, and examples disclosed herein are illustrative only and not intended to be limiting.

### The Disclosure

The following section describes in detail the various configurations, methods and design of specific operating conditions disclosed as a part of this write-up.

The metal-oxide composition consists of two components, namely primary and secondary. In embodiments, the primary metal-oxide is Fe₃O₄. The primary metal-oxide should be able to crack LCF selectively. The secondary metal-oxide can be a combination of oxides of metals selected from Ti, Al, Co, Cu, Mg, Mn, Zn, etc., or even a combination complex like MgAl₂O₄. The secondary metal-oxide serves to strengthen the primary metal-oxide and can enhance reactivity by forming complexes which have a better thermodynamic selectivity than iron-oxide alone. The oxygen-carrier metal-oxide may contain a combination of primary and secondary metal-oxides in varying weight percentages accompanied by dopants to increase the overall activity of the metal oxide. The metal-oxide can be prepared by methods including but not limited to extrusion, pelletizing, co-precipitation, wet-impregnation, and mechanical compression. Techniques, like sintering the synthesized metal-oxide or adding a binder, can be used to increase the strength of the metal-oxide.

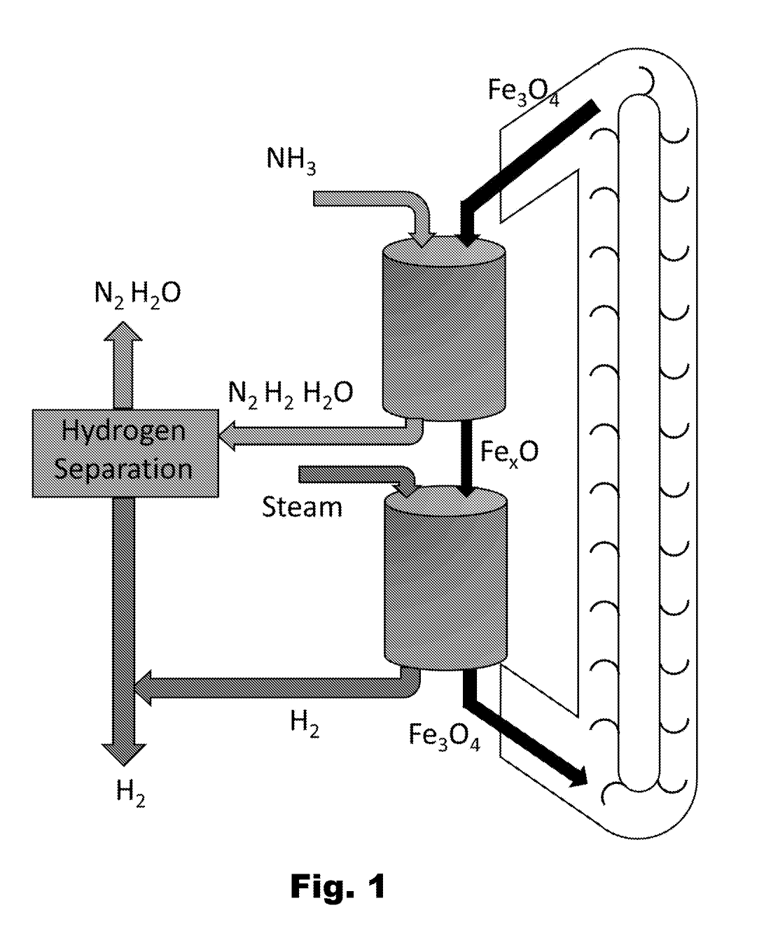

A model metal-oxide composition consists of a primary metal-oxide of Fe₃O₄ supported on a secondary metal oxide of the formula MgAl₂O₄. This complex can be Fe₃O₄ rich, MgAl₂O₄ rich or even have an overall non-stoichiometric support composition. The feedstock for this application can be any LCF including but not limited to ammonia, hydrazine hydrate, carbohydrazide, and hydrogen sulfide. In some embodiments, the LCF is ammonia. FIG. 1 shows the conceptual schematic of the proposed configuration. The process configuration is described using ammonia as an example of LCF. As illustrated in FIG. 1, the proposed process employs a novel metal-oxide reaction with NH₃ to produce a mixture of N₂, H₂, and H₂O at an operating temperature of 450° C. (450° C. used as an example temperature) in the reducer. The reduced metal-oxide then performs water-splitting to generate pure H₂ in the oxidizer resulting in a reduced energy penalty for separating N₂ and H₂ over the conventionally used thermal cracking of ammonia technology which forms one mixed stream of the cracked products. The net-combination of the reducer and combustor performance is such that the total H₂ recovered from NH₃ feed is >99.99%. The H₂ can be further purified to fuel cell grade directly.

The proposed chemical looping reaction scheme can alleviate shortcomings in the conventional ammonia to hydrogen (ATH) process. Compared to the conventional technique, the ATH chemical looping process can increase the overall H₂ production efficiency by >20% and the thermochemical efficiency by >12.7%. The process platform is based on a co-current moving bed reactor system design to maximize NH₃ conversion to H₂ while minimizing the capital cost associated with the chemical looping reactor size. As discussed earlier conventional catalytic cracking techniques are limited by kinetics at temperatures of 450° C. or lower, on the other hand, the co-current moving bed ATH process offers an effective control over the residence time of both the gas and solid phases and thus drives the reaction to thermodynamic equilibrium at 450° C. The temperature 450° C. is used to illustrate the process, this can be further extended to temperatures up to 2000° C. Further, at these low operating temperatures, mechanical conveying systems can be employed between the reducer and combustor which can minimize the energy penalty and particle attrition for transporting the metal-oxide solids.

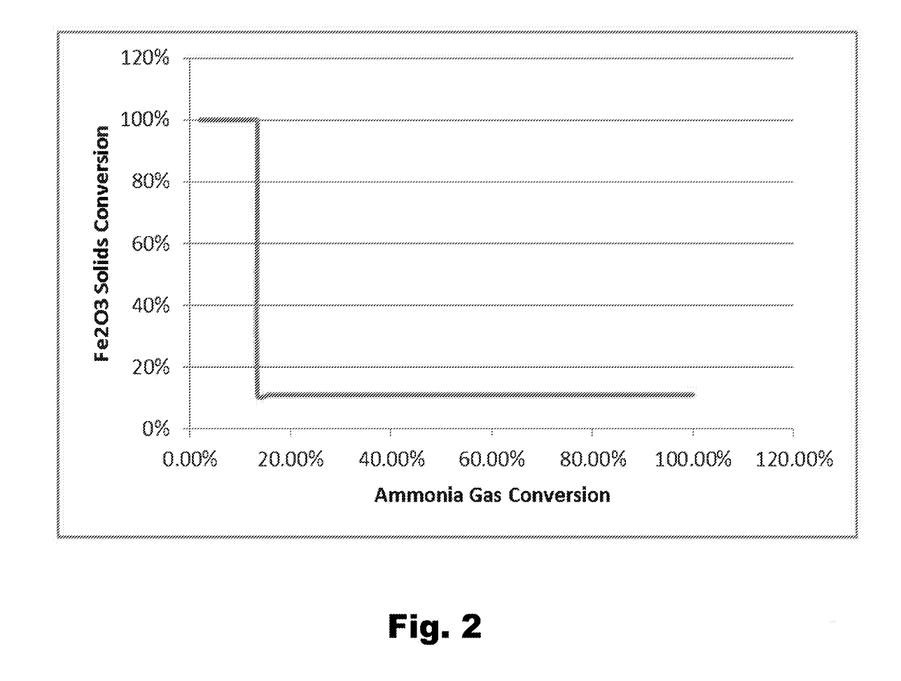

FIG. 2 shows the thermodynamic phase diagram of the NH₃—Fe—O system at 450° C. and 1 atm. The y-axis is the solids conversion of the Fe₂O₃ phase, wherein a solids conversion of 100% denotes complete oxygen transfer from Fe₂O₃ to NH₃. The NH₃ conversion is displayed in terms of the amount of H₂O production per mole of NH₃, with a value of 100% conversion denoting the formation of 1.5 moles H₂O per mole of NH₃.

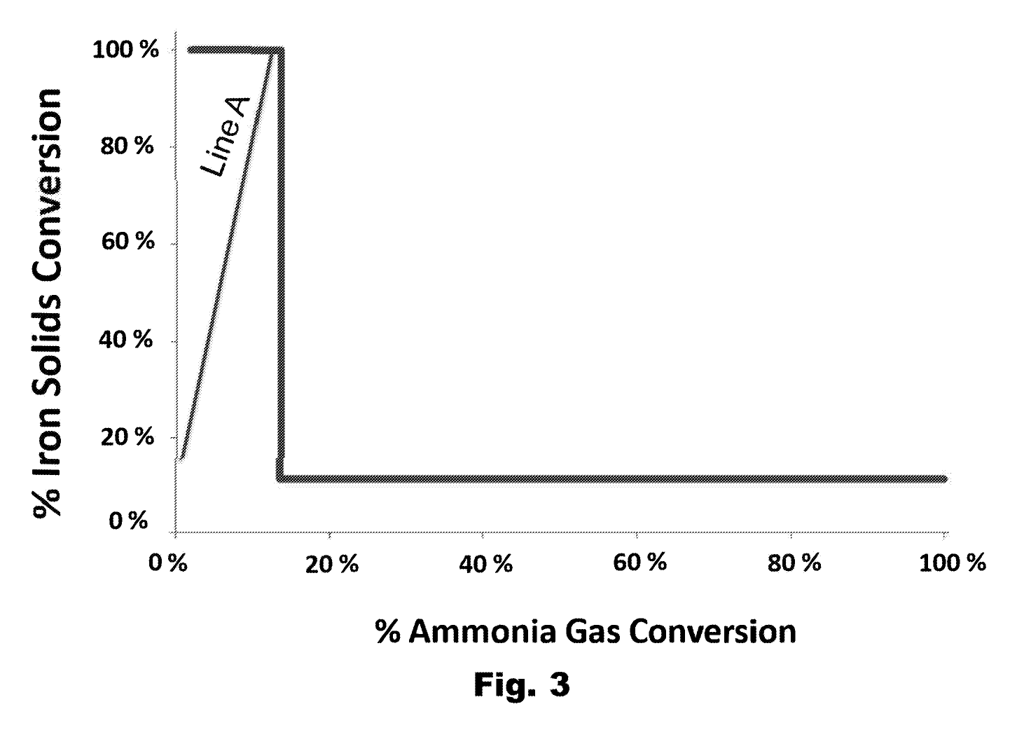

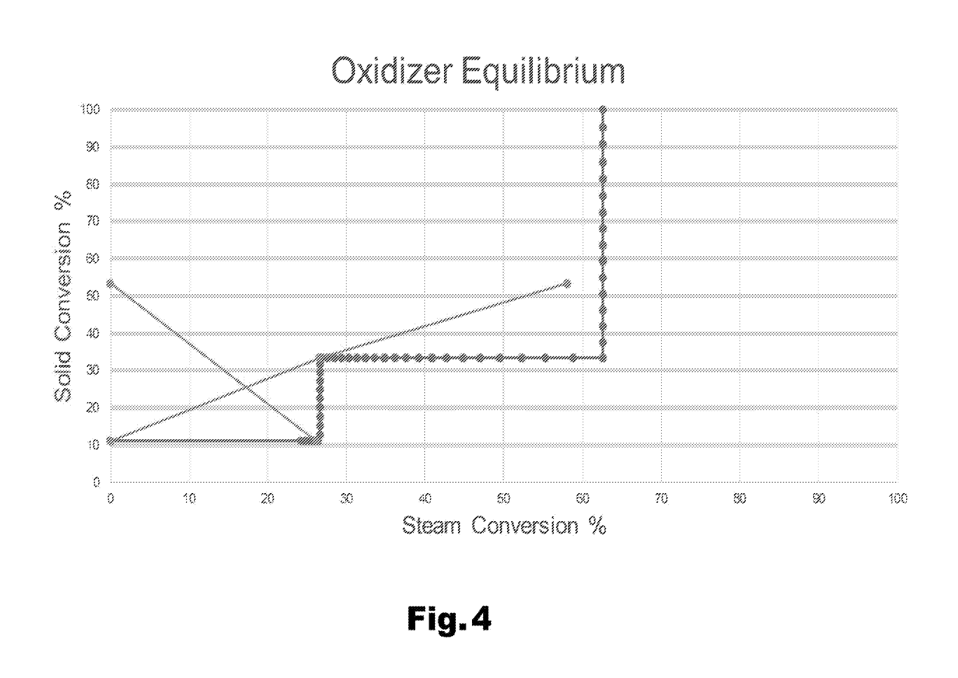

FIG. 3 shows the various operating conditions that can be obtained in the reducer reactor of the LCF to H₂ system. The choice of an operating condition for the reducer reactor system shown in FIGS. 1, 2 and 3 is made based on FIG. 4, which shows the phase diagram of the H₂—O—Fe system.

FIG. 4 shows that the steam re-oxidation from Fe (corresponding to 100% solids conversion) yields Fe₃O₄ (corresponding to 11% solids conversion) as the highest thermodynamically feasible oxidation state. This led to the choice of Fe₃O₄ as the input for the reducer reactor as shown in FIG. 3. The operating line is chosen based on 11% solids conversion and yields a gas conversion of 13.4%, corresponding to an outlet gas composition of 0.201 moles H₂O, 1.29 moles of H₂, ˜1.5 moles N₂ per mole of NH₃. This performance is constant beyond a Fe₃O₄/NH₃ ratio of 0.05. However, the operating condition depicted in Line A corresponds to a Fe₃O₄/NH₃ ratio of 0.4 to have good heat balance conditions in the combined system. The oxygen lost as H₂O is recovered in the oxidizer, yielding an H₂ production efficiency of ≥99% (i.e. ≥1.495 moles of H₂ per mole of NH₃) based on FIG. 4. The flexibility to operate under a wide range of Fe₃O₄/NH₃ ratios is important as the solids flowrate is used to transfer heat from the exothermic oxidizer reactor to the endothermic reducer reactor resulting in a near autothermal condition. This minimizes the thermal energy penalty for H₂ production. The reducer and the oxidizer both are proposed to be operated as packed moving bed type system to minimize physical attrition to the oxygen carrier particles. The operation of a counter-current moving bed oxidizer has advantages in terms of reducing the net steam consumption while adjusting the gas and solid phase residence times for reaching thermodynamic equilibrium. In the configuration proposed in FIG. 1, a mechanical conveyor type system is proposed to transport the solids to the reducer reactor. The reducer and the oxidizer reactors can be operated as co-current and counter-current moving beds, fluidized beds or even fixed bed type systems. The temperature and pressure of operation for yielding a >99% H₂ production efficiency can be between 400° C. to 800° C., and 1 bar to 30 bar respectively. It should be noted that lower temperatures and pressures are preferred for commercial modules.

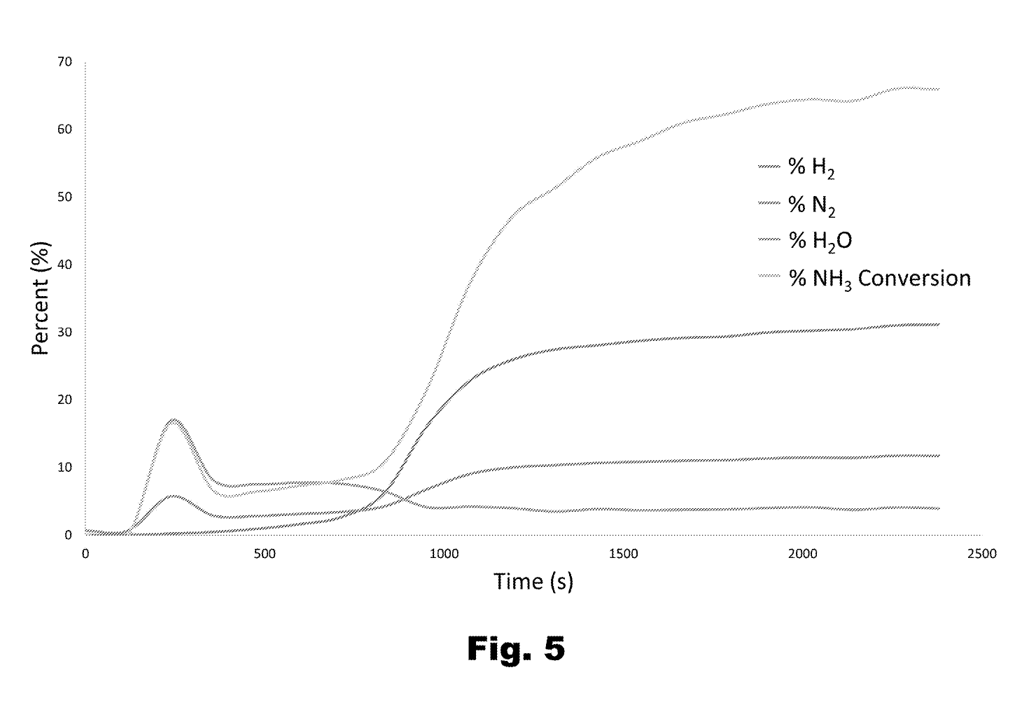

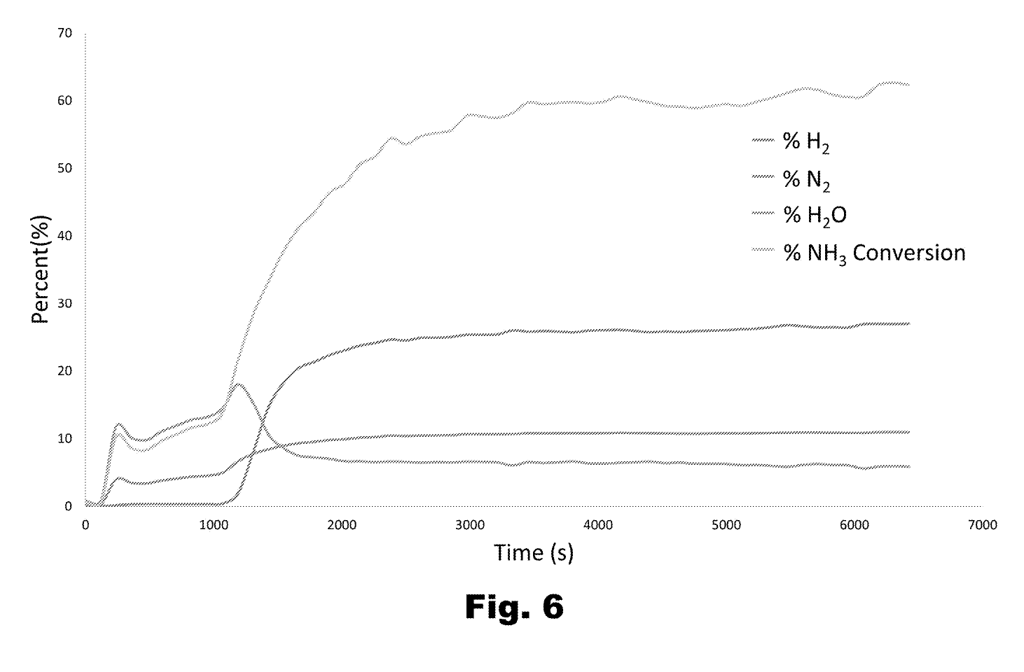

FIG. 5 and FIG. 6 shows the results of proof-of-concept laboratory studies using the iron-based catalytic metal oxide (Fe₃O₄) performed in a fixed bed system. This fixed bed represents the reducer section in the looping system. In FIGS. 5 and 6, the gas analysis of the outlet of the fixed bed is depicted. Both the fixed beds represented by FIGS. 5 and 6 were run at 600° C. and 1 atm pressure with a GHSV of 500 hr⁻¹ and 150 hr⁻¹ respectively. Spherical particles of Fe₃O₄ were used in the fixed bed for this test. For the fixed bed tests, spherical particles were synthesized from chemical grade compounds. These particles were then calcined under inert conditions at a temperature of 950° C. The experiments with a GHSV of 500 hr⁻¹ and 150 hr⁻¹ have been referred to as Experiment A and B respectively.

Both the FIGS. 5 and 6 show a steady increase in the N₂ and H₂ concentration before reaching a steady state. The conversion for NH₃ goes up to approximately 65% and 62% for 500 hr⁻¹ and 150 hr⁻¹ respectively. Unlike the conventional catalytic NH₃ decomposition, H₂O also is a product which is in significant quantities. This loss of H₂ in the form of H₂O from the reducer is balanced out by the re-oxidation reaction in the oxidizer.

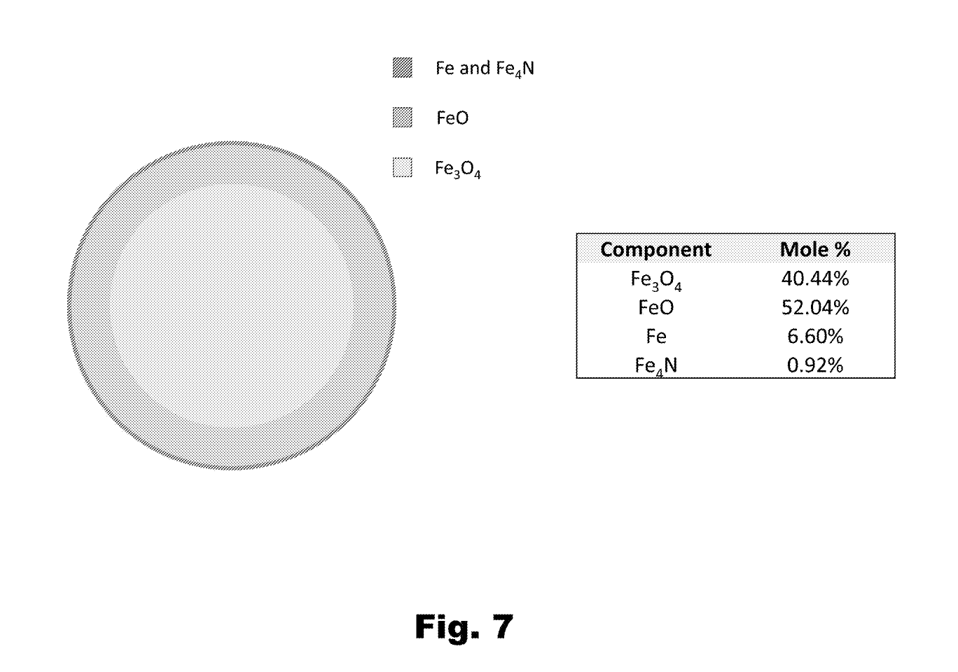

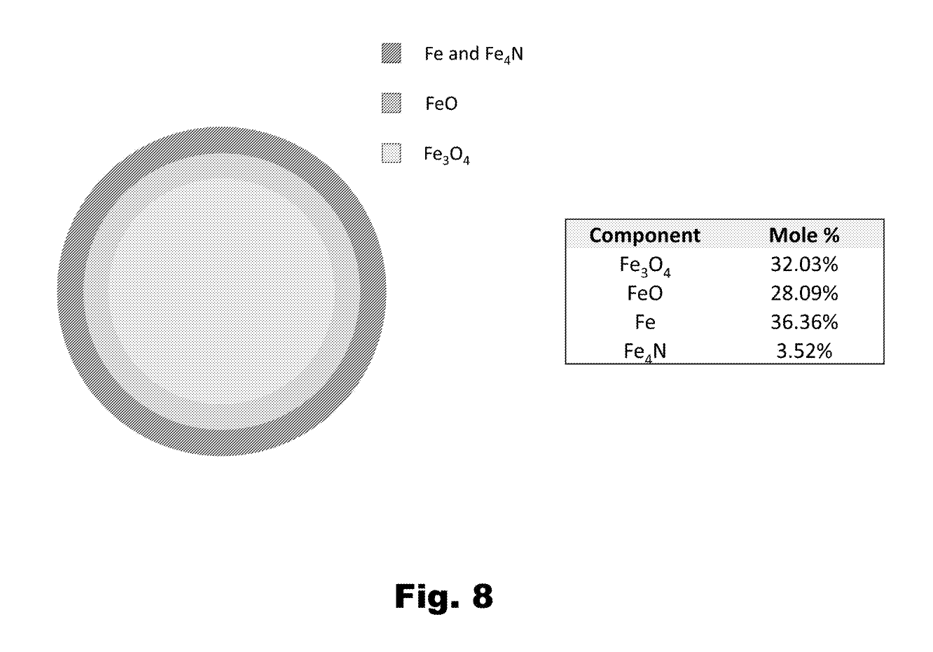

FIGS. 7 and 8 represent the solid composition on the top of the fixed bed. This was calculated from the X-Ray Diffraction (XRD) analysis done on the samples from 500 hr⁻¹ and 150 hr⁻¹ GHSV for FIGS. 7 and 8 respectively. The particles form a core shell structure with respect to the reduced phases, as seen in FIGS. 7 and 8. The Fe layer is the dominant surface layer corresponding to a core-shell structure and the phase consistent with the calculated Equilibrium constant for both the GHSVs.

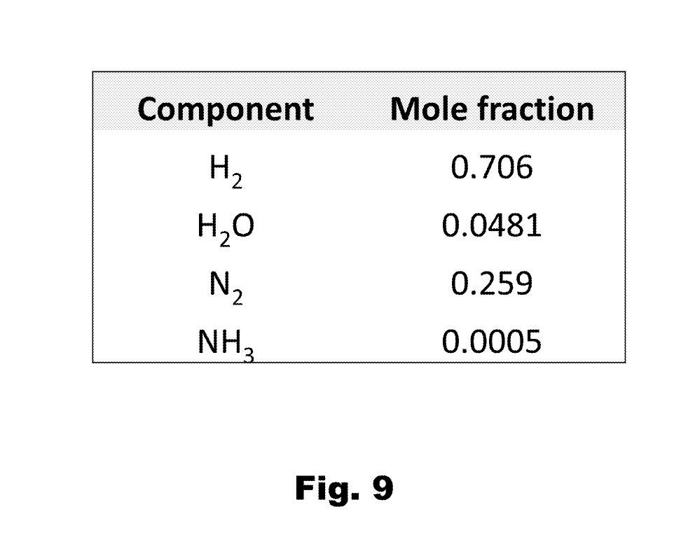

FIG. 9 depicts the gas phase data of a simulated counter-current bed with Fe₃O₄—MgAl₂O₄ particles. These particles include 50% Fe₃O₄ and 50% MgAl₂O₄ by weight and are synthesized and sintered in the same way as the Fe₃O₄ particles. For a simulated counter-current moving bed, a solid profile of a counter-current moving bed was setup with 50% of the bed filled with reduced particles and 50% of them filled with the oxidized particles. The bed was setup in such a way that the reduced particles would meet the gas coming into the reactor and the gas exited the reactor with being in contact with the oxidized particles. For this Fe₃O₄—MgAl₂O₄ particles were reduced under hydrogen to yield Fe—MgAl₂O₄ particles, which would act as reduced particles.

As seen from FIG. 9, an average ammonia conversion of 99.9% was achieved with the counter current moving bed configuration. The figure represents the mole fractions of the products and the unreacted ammonia during steady state run operation of the moving bed. This experiment has been referred to as Experiment C.

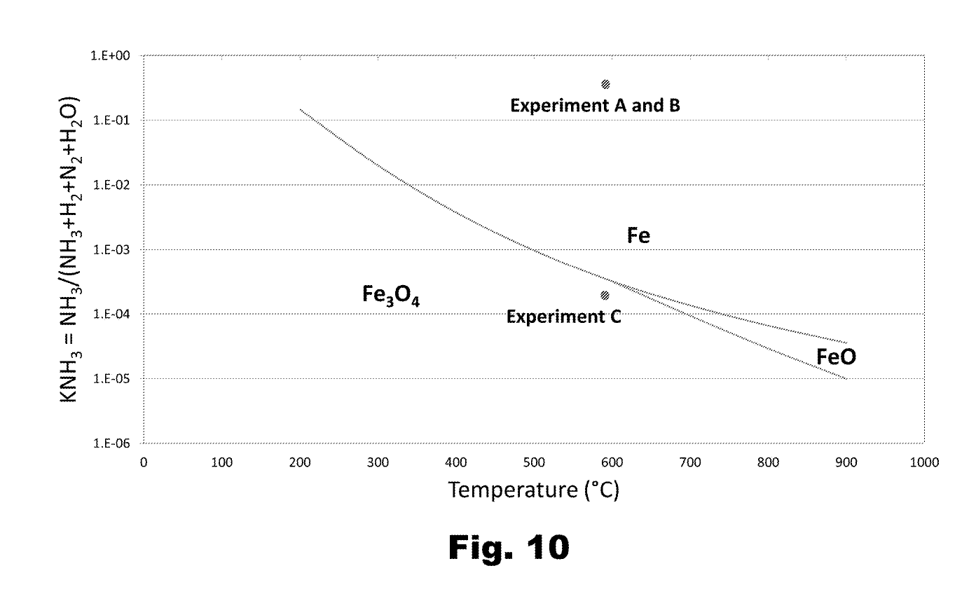

The steady state values for NH₃ reaction with Fe₃O₄ for different residence times and gas-solid contact pattern are plotted in terms of a NH₃ cracking equilibrium constant (K_{NH3}=C_{NH3}/(C_{NH3}+C_{N2}+C_{H2}+C_{H2O}). The experiments were carried out at 600° C. for demonstrating control over the equilibrium composition in terms of the equilibrium constant and different metal-oxide phases. FIG. 10 shows the K_{NH3} calculated for these experimental runs for different thermodynamic contact patterns. Experiment A and B show a calculated equilibrium constant that is consistent with the final solids contact stage being Fe. Experiment C shows a calculated equilibrium constant that is consistent with the final solids contact stage being Fe₃O₄. These experimental data points show that the system performance can be controlled using different gas-solid contact pattern and yield further experimental proof for the thermodynamic performance.

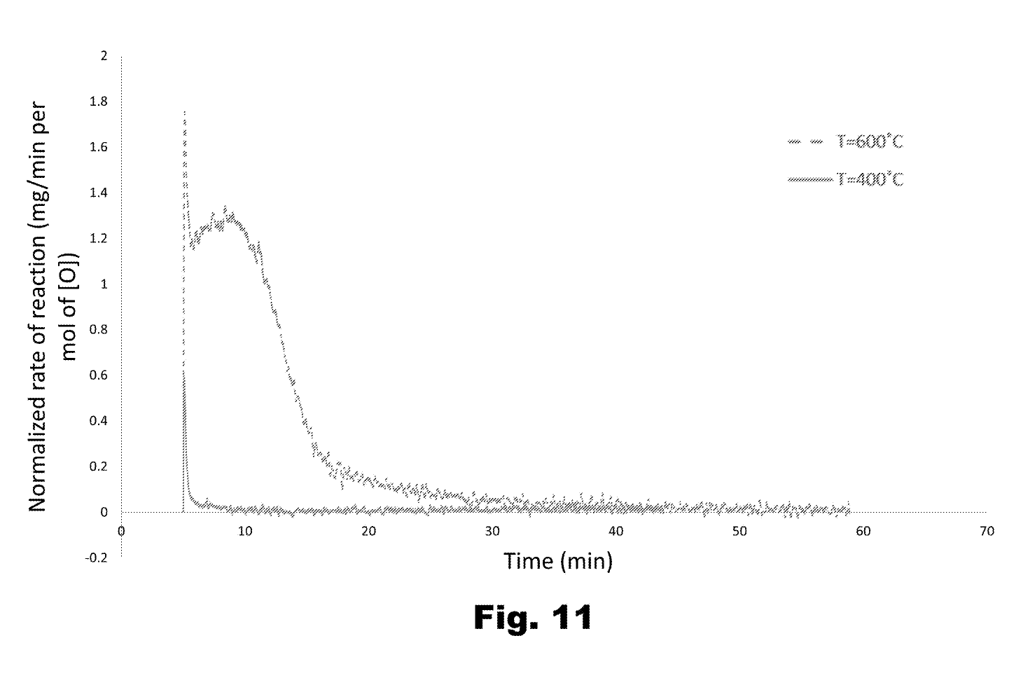

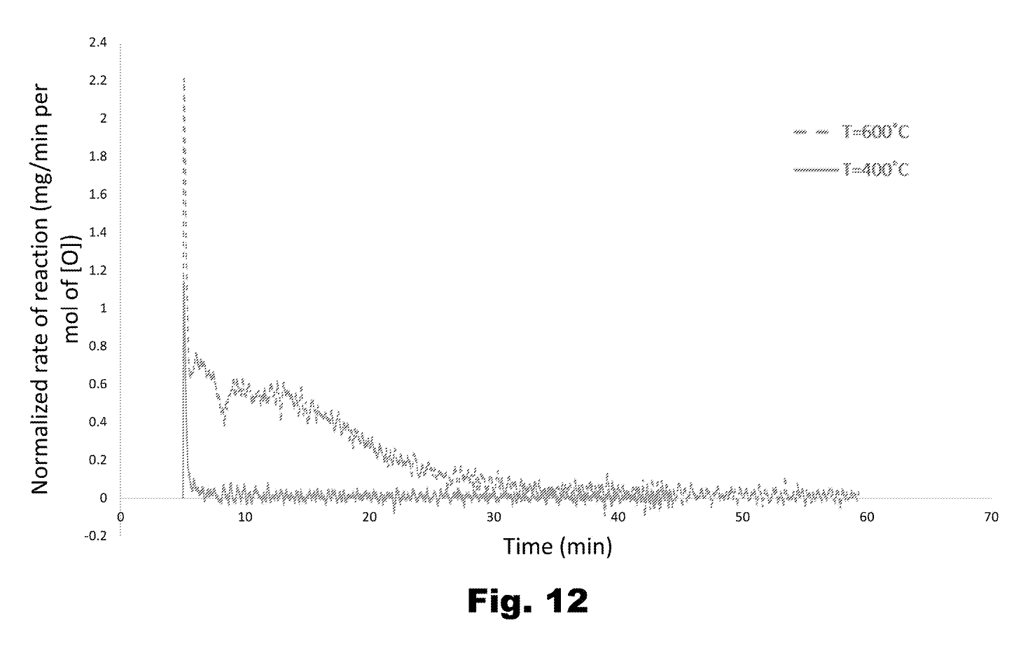

FIGS. 11 and 12 show the normalized rate of reaction of the metal oxide and ammonia at 400° C. and 600° C. FIG. 11 represents the normalized rate of reaction of pure Fe₃O₄ and FIG. 12 does the same for Fe₃O₄—MgAl₂O₄. For both the metal oxides, ammonia reacts with the metal oxide, reducing it in the process which can be measured as a decrease in weight of the metal oxide in a thermogravimetric analyzer. As there is a reduction in weight the rate of weight change is a negative number, which has been considered in an absolute fashion in both FIGS. 11 and 12. These rates have been normalized with respect to the fresh active oxygen content. For the two FIGS. 11 and 12, the active oxygen that reacts with ammonia comes from Fe₃O₄.

Both FIGS. 11 and 12 are a proof of concept for ammonia decomposition at 400° C., as there is an appreciable reduction of the metal oxide. From a kinetics standpoint, both FIGS. 11 and 12 show a higher reduction rate at 600° C. than 400° C. The 400° C. graphs for both FIGS. 11 and 12 have a non-zero rate of reduction after the initial spike in the reaction. With a moving bed configuration, the residence time and the amount of metal oxide reduced can be very accurately controlled and thus a unit can be run within the bounds of the initial spike in the reaction ensuring efficient utilization of the kinetics of this system.

### Embodiments

The following are embodiments of the disclosure.

(1) A system configuration is proposed, utilizing a low carbon fuel and an H₂ production efficiency of >99% from these LCFs. The system configuration itself includes two primary reactors, a reducer and an oxidizer reactor each of which can be a co-current or a counter-current moving bed, fluidized bed or a fixed bed.

(2) A system configuration, in-conjunction with Embodiment 1, converts LCFs to H₂, using an (Fe) to LCF (C) molar ratio which can vary from 0.01 to 5.0. In certain embodiments, the molar ratio is about 0.01, about 0.05, about 0.1, about 0,15, about 0.2, about 0.25, about 0.3, about 0.35, about 0.4, about 0.45, about 0.5, about 0.55, about 0.6, about 0.65, about 0.7, about 0.75, about 0.8, about 0.85, about 0.9, about 1, about 1.5, about 2, about 2.5, about 3, about 3.5, about 4, about 4.5 or about 5 The temperature of operation can vary between 50° C. to 2000° C. In certain embodiments, the temperature may vary between 400° C. to 1190° C., The pressure of operation can vary between 1 atm and 30 atm. In certain embodiments, the pressure is about 1 atm, about 2 atm, about 3 atm, about 4 atm, about 5 atm, about 6 atm, about 7 atm, about 8 atm, about 9 atm, about 10 atm, about 11 atm, about 12 atm, about 13 atm, about 14 atm, about 15, atm, about 16 atm, about 17 atm, about 18 atm, about 19 atm, about 20 atm, about 21 atm, about 22 atm, about 23 atm, about 24 atm, about 25 atm, about 26 atm, about 27 atm, about 28 atm, about 29 atm, or about 30 atm.

(3) A reactor configuration is proposed, in conjunction with Embodiment 1, which has a flexible injection location for the LCF stream into the reactor system. The injection location can be situated on the top, middle or bottom section of the system, such that sufficient residence time for reaching thermodynamic equilibrium for the final adjusted gas composition is achieved.

(4) A system configuration of the co-current moving bed reducer reactor can handle a variety of low or no carbon feedstocks, including but not limited to ammonia, hydrazine hydrate, carbohydrazide, hydrogen sulfide when used in conjunction with design considerations being satisfied for Embodiments 1 and 2. The invention reduces the energy input to separate and purify hydrogen from the product streams compared to conventional catalytic cracking process.

It is understood that the foregoing detailed description and accompanying examples are merely illustrative and are not to be taken as limitations upon the scope of the disclosure. Various changes and modifications to the disclosed embodiments will be apparent to those skilled in the art. Such changes and modifications, including without limitation those relating to the chemical structures, substituents, derivatives, intermediates, syntheses, compositions, formulations, or methods of use of the invention, may be made without departing from the spirit and scope thereof.

### REFERENCES

(1) Okamura, J, et. al. (2011). Ammonia decomposition catalysts and their production processes, as well as ammonia treatment method, US 2011/0176988 A1.

(2) Kodesch, K., Et. al. (2005), Ammonia cracker for production of hydrogen, U.S. Pat. No. 6,936,363 B2.

(3) Yin S. F., et. al., A mini-review on ammonia decomposition catalysts for on-site generation of hydrogen for fuel cell applications, Applied Catalysis A: General, 2004, 277, 1-9

(4) T. E. Bell L. Torrente-Murciano, H₂ Production via Ammonia Decomposition Using Non-Noble Metal Catalysts: A Review, Top Catal, 2016, 59, 1438-1457

(5) Makepeace J. et. al., Ammonia decomposition catalysis using non-stoichiometric lithium imide, Chem. Sci., 2015, 6, 3805.

1. A system for converting a carbon-neutral or low-carbon fuel, the system comprising:
a first reactor comprising a plurality of particles in which a primary metal oxide is disposed on a support, and an inlet for providing a carbon-neutral or low-carbon fuel, wherein the first reactor is configured to reduce the primary metal oxide to produce a reduced metal or a reduced metal oxide; and a second reactor configured to oxidize at least a portion of the reduced metal or reduced metal oxide from the first reactor, to regenerate the primary metal oxide.

2. The system of claim 1, wherein the fuel is selected from the group consisting of ammonia, hydrazine, carbohydrazide, and hydrogen sulfide.

3. The system of claim 2, wherein the fuel is ammonia.

4. The system of claim 1, wherein the system is configured to operate at a temperature of between 50° C. and 2000° C.

5. The system of claim 1, wherein the system is configured to operate at a pressure of between 1 atm and 30 atm.

6. The system of claim 1, wherein the system is configured to operate at a GHSV of between 50 hr⁻¹ and 5000 hr⁻¹.

7. The system of claim 1, wherein the first reactor comprises a co-current moving bed reactor, a counter-current moving bed reactor, a fluidized bed reactor, or a fixed bed reactor.

8. The system of claim 1, wherein the second reactor comprises a co-current moving bed reactor, a counter-current moving bed reactor, a fluidized bed reactor, or a fixed bed reactor.

9. The system of claim 1, wherein the inlet for the fuel is situated at the top, in the middle, or at the bottom of the first reactor.

10. The system of claim 1, wherein the primary metal oxide is Fe₃O₄.

11. The system of claim 1, wherein the support is selected from the group consisting of oxides of Ti, Al, Co, Cu, Mg, Mn, and Zn, or any combination thereof.

12. The system of claim 1, wherein the support is MgAl₂O₄.

13. The system of claim 1, further comprising a hydrogen separation unit.

14. A method of converting a carbon-neutral or low-carbon fuel, the method comprising:
reducing a primary metal oxide in a reduction reaction between the fuel and the primary metal oxide, to produce a reduced metal or a reduced metal oxide, in a first reactor, thereby producing hydrogen; and oxidizing at least a portion of the reduced metal or reduced metal oxide with an oxidant, in a second reactor, thereby regenerating the primary metal oxide.

15. The method of claim 13, wherein the fuel is selected from the group consisting of ammonia, hydrazine, carbohydrazide, and hydrogen sulfide.

16. The method of claim 14, wherein the fuel is ammonia.

17. The system of claim 13, comprising conducting the method at a temperature of between 50° C. and 5000° C.

18. The method of claim 13, comprising conducting the method at a pressure of between 1 atm and 30 atm.

19. The method of claim 13, wherein the first reactor comprises a co-current moving bed reactor, a counter-current moving bed reactor, a fluidized bed reactor, or a fixed bed reactor.

20. The method of claim 13, wherein the second reactor comprises a co-current moving bed reactor, a counter-current moving bed reactor, a fluidized bed reactor, or a fixed bed reactor.

21. The method of claim 13, comprising introducing the fuel at the top, in the middle or at the bottom of the first reactor.

22. The method of claim 13, wherein the primary metal oxide is Fe₃O₄.

23. The method of claim 13, wherein the support is selected from the group consisting of oxides of Ti, Al, Co, Cu, Mg, Mn, and Zn, or any combination thereof.

24. The method of claim 13, wherein the support is MgAl₂O₄.

25. The method of claim 13, further comprising a step of separating the hydrogen from any co-products.
